(19) United States
(12) Patent Application Publication
(10) Pub. No.: US 2023/0220297 A1
(43) Pub. Date: Jul. 13, 2023

(54) METHOD OF OIL EXTRACTION

(71) Applicant: Prehm BFHK, LLC, Overland Park, KS (US)

(72) Inventor: Anthony Prehm, Overland Park, KS (US)

(21) Appl. No.: 17/943,512

(22) Filed: Sep. 13, 2022

Related U.S. Application Data
(60) Provisional application No. 63/243,803, filed on Sep. 14, 2021.

(51) Int. Cl. C11B 1/10

(52) U.S. Cl. CPC C11B 1/104

(57) ABSTRACT

The invention relates to a method of extracting oil from plant matter including treating a liquid or liquefied plant material to a high pressure extraction step by contacting the plant material with CO₂ at a pressure between 100 and 3000 psig. And then separating the CO₂ and the extracted oil to form an extracted plant meal. Preferably the extracted plant meal comprises less than 2 wt % of residual oil. The plant material preferably has not been previously extracted with a hydrocarbon solvent and is not heat treated during the extraction step.

### CLAIM OF PRIORITY

This application claims the benefit of U.S. Provisional Application 63/243,803, filed on Sep. 14, 2021, which is incorporated by reference.

### FIELD OF THE INVENTION

The invention relates to a system and method of extracting oil from plant material, including oilseeds, and to systems and methods of producing animal feed with low residual oil content.

### BACKGROUND OF THE INVENTION

The production of animal feed from oilseeds has been around for decades if not centuries. Traditionally, the process includes extruding, pressing, conditioning and/or sizing mechanically pressed oilseeds to separate the meal from the oil with meal being used for animal feed. Known methodologies in the oilseed extruding and pressing industry provides meal that has a final residual oil in the meal ranges from 5.5% to 10% by weight. While this meal is valuable and saleable in the market place as animal feed, finish meal with even lower weight percentages of oil is preferred. Further processing of the meal is required to reduce the weight percentage of oil.

Additionally, ethanol processes from corn and other high starch grains produce a product known as WDGS (Wet Distillers Grains w/Soluble) that contains high percentages of residual oil (e.g. 3-7% by weight). The WDGS meal is either sold “as is” or dried to produce a saleable feed product known as DDGS (Dried Distillers Grains w/Soluble). These are byproducts of the ethanol production and sold as an animal feed into the livestock industry. Further reducing the oil content of WDGS and DDGS would create a more desirable animal feed.

Hexane extraction of oil is a well-known and highly utilized technology through the oilseed industry. The hexane extraction process utilizes hexane (a petroleum-based solvent) to extract the oil from the prepared oilseed product through submersion of the oil rich oilseeds in the hexane. Hexane is heavily regulated by the EPA as an air pollutant and hexane has a low flash point (146° F.) which classifies it as a hazardous material in the US. Because of the costs and risks associated with hexane, an improved method of removing residual oil from plant material (such as animal feed meal produced through mechanical separation) and other higher fat products is needed.

### SUMMARY OF THE INVENTION

The invention relates to a method of extracting oil from plant matter including treating a liquid or liquefied plant material to a high pressure extraction step by contacting the plant material with CO₂ at a pressure between 100 and 3000 psig. And then separating the CO₂ and the extracted oil to form an extracted plant meal. Preferably the extracted plant meal comprises less than 2 wt % of residual oil. The plant material preferably has not been previously extracted with a hydrocarbon solvent and is not heat treated during the extraction step. High pressure extraction can be integrated into existing systems to improve the quality and value of the extracted plant meal, along with increased oil yields with reduced costs.

### BRIEF DESCRIPTION OF THE DRAWINGS

FIG. 1 shows, schematically, the high pressure extraction method.

### DETAILED DESCRIPTION

The present method is used to improve the extraction yield of an oil from plant material such as grains or seeds (e.g. a nut or an oilseed) such that the residual oil content in the resultant meal has been reduced. In a preferred embodiment, the method improves the extraction yield of oil from an oilseed. One area of particular relevance is in the production of animal feed.

The method is flexible in that it can be integrated in to existing extraction processes, and can be integrated at different steps in existing processes. While not required, the method may be repeated to optimize the oil yield of the extraction process. The method preferably operates on starting material that has oil content of greater than 30%, 25%, 20%, 15%, 10%, 7%, 5%, or 3% by weight. The resultant meal after extraction according to this method preferably has an oil content that is at least 30%, 40%, 50%, 60%, 70%, 80%, 90%, 95%, 96%, 97%, 98% or 99% less oil content than the starting material. The resultant meal after extraction according to this method preferable has an oil content that is less than 3.00%, 2.50%, 2.00%, 1.50%, 1.00%, 0.75%, 0.50%, or 0.25% by weight.

The plant material may suitably be processed by methods known in the art to produce the starting material, including mechanical separation. Such processing typically comprises the following steps, usually in this order: cleaning, cracking, dehulling, conditioning, and/or flaking. Cleaning typically involves metal removal (such as with a magnet separator) followed by screening to remove fines (such as dust and sand) and oversize impurities (such a rocks and fibrous pods). Cracking involves reducing the size (such as reducing an oilseed to 4-6 pieces) and making the oil-bearing portion of the plant material (e.g. meat of a seed) available for extraction. For example, cleaned oilseed may be passed through cracking rolls to break open the seeds and reduce the size to a specified size range. Cracked seeds may be dehulled such as by air aspiration and optional screening where the light hulls are separated from the heavy oil-bearing (meat) portion of the seed. The meat may be conditioned by heating, prior to extruding (a process of high pressure that ruptures the oil cells) in the process of recovering the oil from the meal. For plant material other than seeds, similar steps may be utilized to clean, reduce in size, or condition the material to improve the availability of oil during the extraction process.

With appropriately prepared starting materials, a high pressure extraction method is utilized to improve the extraction yield of an oil from the plant material, thus improving the efficiency of the extraction operation. This results in more oil extracted from the plant material and resultant meal less oil and thus is lower in fat content. Lower fat content meal is especially desirable in animal feeds. The high pressure extraction method also provides a high quality oil; that is, it has very few impurities, and preferably meets the National Oilseed Processors Association's trading rules requirements for crude degummed oil, once refined oil, or fully refined oil, according to the American Oil Chemists' Society (AOCS), official methods as set forth in the trading rules. The extracted oil is preferably also substantially free of impurities. Here, “substantially free of impurities” should be understood to include oil in which the amount of total impurities is less than the amount of permitted individual impurities as set forth in AOCS official methods for a given impurity.

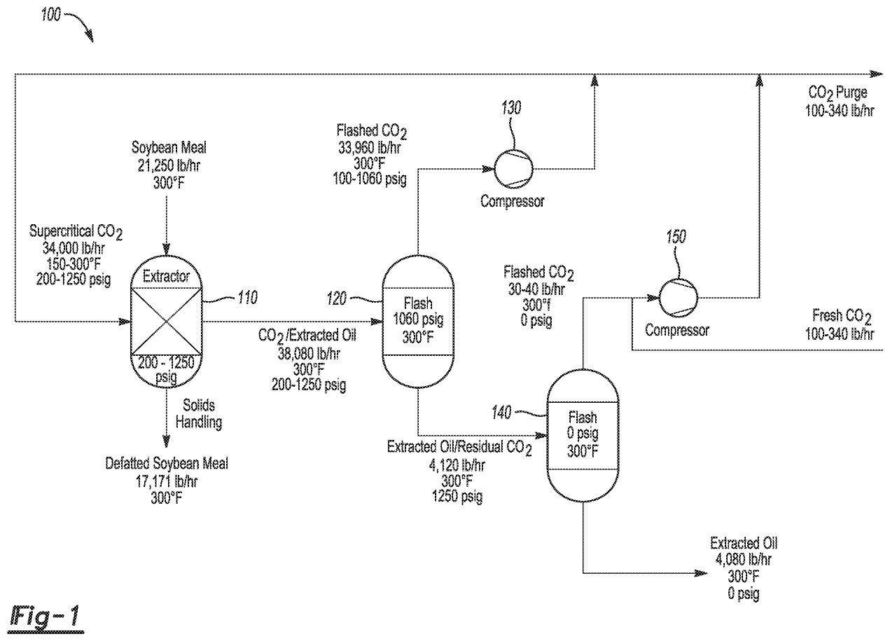

FIG. 1 shows a schematic layout of a system for conducting a CO₂ extraction method. The plant material is introduced into an extractor vessel 110 along with CO₂, resulting in defatted meal, and a combination of CO₂ and extracted oil. The CO₂/extracted oil combination is passed to a flash vessel 120, where the pressure is reduced, thus causing the CO₂ to turn to a gas and be driven off. Flashing also drives off water. The flashed CO₂ is passed to a compressor 130 for compression and subsequent reuse. Likewise, water is collected for reuse. The extracted oil is passed to a subsequent flash vessel 140, where the pressure is again reduced (preferably to ambient), again causing any residual CO₂ to turn to a gas and to be driven off. Again, this also causes residual water to be driven off. This flashed CO₂ is passed to a compressor 150 for compressing and subsequent reuse or purging. Likewise, water is collected for reuse. The resultant extracted oil is dry and clear and otherwise essentially free of CO₂ and impurities and ready for sale. The operating parameters shown in FIG. 1 are preferred ranges, however, other combinations of parameters are contemplated.

The method includes a high pressure extraction method where the meal is subjected to pressures above ambient pressure, preferably significant above ambient pressure. The operating pressure in extraction method is preferably between 200 and 3000 psig, and more preferably between 900 and 2000 psig. A variety of open-ended ranges of pressures are also contemplated, such as more than 200 psig, more than 300 psig, more than 400 psig, more than 500 psig, more than 600 psig, more than 700 psig, more than 800 psig, more than 900 psig, more than 1000 psig, more than 1100 psig, more than 1200 psig, more than 1300 psig, more than 1400 psig more than 1500 psig, more than 1600 psig, more than 1700 psig, more than 1800 psig, and more than 1900 psig; also, less than 300 psig, less than 400 psig, less than 500 psig, less than 600 psig, less than 700 psig, less than 800 psig, less than 900 psig, less than 1000 psig, less than 1100 psig, less than 1200 psig, less than 1300 psig, less than 1400 psig, less than 1500 psig less than 1600 psig, less than 1700 psig, less than 1800 psig, less than 1900 psig, and less than 2000 psig. A variety of bounded ranges are also contemplated, such as between 900 and 1500 psig, between 900 and 1300, between 1000 and 1300, and between 1000 and 1500 psig.

The length of time that the starting material is exposed to increased pressure (so called dwell time) is variable. There is generally a proportional relationship between the dwell time and the amount of oil extracted. Longer dwell times result in more oil being extracted, thus lower oil content (by weight) in the resultant meal. In this manner, the time parameter can be used to achieve or control the oil content in the resultant meal. In one preferred embodiment, the meal is subjected to increased pressure for less than 5 minutes, less 4 minutes, less than 3 minutes, less than 2 minutes, less than 1 minute, less than 45 seconds, or less than 30 seconds. In a more preferred embodiment, the meal is subjected to increased pressure for 30 to 45 seconds.

However, increased dwell times do not always lead to increased oil yields, as there are diminishing returns. Indeed, in one preferred embodiment, where the starting material is sprayed into the extraction vessel (such as, in a liquefied form), the contact between and the supercritical fluid causes nearly instantaneous extraction of oil from the meal. In this embodiment, increasing dwell time does not lead to increased oil yields.

The temperature of the material during the high pressure extraction method is variable in that a more or less steady temperature may be used for a given time period. The main parameter used to select a temperature is the melting point or liquefying temperature of the lipid contained in the oil to be extracted. Preferably, the temperature with the extraction vessel is held steady while the material is in the extraction vessel. Preferably, the steady temperature is in the range of 50° F. and 550° F., and more preferably in the range of 100° F. to 350° F. Suitable temperature ranges also include more than 100° F., more than 150° F., more than 200° F., more than 250° F., or more than 300° F.; also, less than 550° F., less than 500° F., less than 450° F., less than 400° F., less than 350° F., less than 300° F., less than 250° F., less than 200° F., or less than 150° F. Preferred bounded ranges of temperature include 200° F. to 400° F., and 275° F. to 350° F. In the alternative, the temperature may be varied across the time period, such as steadily increasing, steadily decreasing, cyclically rising and falling within a range, increasing stepwise, decreasing stepwise, or increasing and decreasing stepwise.

The processing steps that occur before the high pressure extraction method may also influence the desired temperature. For example, it may be beneficial to not input additional heat into the meal at the extraction step because the meal temperature is already high enough from prior processing steps. Indeed, preferably, no additional heat is introduced or added to the material at this step such that residual heat in the material facilitates oil extraction in the high pressure method. This helps to reduce cycle time because there is no need to wait for the material to be heated up and reduce energy costs.

The high pressure extraction method may be performed at one or more different locations in the overall processing of plant material. For example, the method can be performed on material that has already been extruded or cooked, on material that has already been expelled or pressed. The method can also be performed on material after a sizing or grinding step. While typically performed once in the overall processing of an amount of plant material, it contemplated that the high pressure extraction method could be performed more than once on an amount of plant material.

In one preferred embodiment, the high pressure extraction method is performed in a continuous or nearly continuous manner as this reduces the cycle time. A continuous process also results in reduced heat loss from the material, again reducing energy costs. Nonetheless, batch or other syncopated processing at the high pressure extraction method is also contemplated. Indeed, combination processing is also contemplated. For example, starting material may be continuously introduced into an extraction vessel, while defatted meal may be removed from the extraction vessel in batches.

The method may be performed on any amount of starting plant material and at any mass flow rate. Preferably, the method is performed at mass flow rates of starting material of at least 5K lb/hr, at least 10K lb/hr, at least 15K lb/hr, at least 20K lb/hr, at least 25K lb/hr, at least 30K lb/hr, at least 35K lb/hr, at least 40K lb/hr, at least 45K lb/hr, or at least 50K lb/hr. Preferably, the method results in more than 500 lb/hr of resultant oil, more than 1000 lb/hr of resultant oil, more than 2000 lb/hr of resultant oil, more than 3000 lb/hr of resultant oil, more than 4000 lb/hr of resultant oil, more than 5000 lb/hr of resultant oil, more than 6000 lb/hr of resultant oil, more than 7000 lb/hr of resultant oil, more than 8000 lb/hr of resultant oil, more than 9000 lb/hr of resultant oil, or more than 10000 lb/hr of resultant oil.

It is believed that there is a proportional relationship between pressure and throughput of method; that is, higher pressures lead to higher mass flow rates through the system. This is particularly true for starting materials that have higher weight % of oil. Thus, for example, for an oilseed starting material to have the same throughput as DDGS, a higher pressure is likely desirable. Similarly, it is believed that there is a proportional relationship between temperature and throughput of the method; that is, higher temperatures lead to higher mass flow rates through the system. Again this is thought to be particularly true for starting materials that have higher weight % of oil. Thus, for example, for an oilseed starting material to have the same throughput as DDGS, a higher temperature is likely desirable.

Pressure and temperature can be varied in combination to achieve the desire throughput for a given starting material. For example, both temperature and pressure can be increased, or on the other hand, pressure increased and temperature decreased. Also, one parameter can be held steady while the other is varied for a starting material. In a preferred embodiment, pressure is varied to increase throughput while temperature is not; this is because it is easier and quicker to change the pressure in the extractor vessel than to heat or cool the starting material.

There is also an inverse relationship between the size of the vessels needed and the pressure utilized. That is, higher pressures can utilizes smaller vessel, thus allow for a more compact operation requiring less square footage and less volume to house the extraction method.

In one preferred embodiment, the pressure and temperature are selected so that the solvent (e.g. CO₂) utilized is in a supercritical state, although sub-supercritical pressure and temperature combinations are also contemplated.

The control scheme for the system as a whole will preferably be automated to allow the high pressure extraction method to be included in the system as desired and to otherwise insure that the system is operating efficiently. The control scheme will preferably operate all aspects of the various components of the system and the steps of the method including start-up, operation, and shutdown of the system.

The solvent used in the high pressure extraction method may be selected in from water, alcohols, hydrocarbons, carbon dioxide (CO₂), and other gases and liquids, and combinations thereof, and generally are selected based on the specific oil that is being extracted, or based on the universality of the solvent. The preferred solvent is CO₂. CO₂ extraction has the added benefit that it does not render the resultant meal and oil to be non-organic (and can thus maintain an organic food label), compared to extraction via hydrocarbon solvents. In a preferred embodiment, the starting material has not been subjected to an extraction step (e.g. a solvent extraction) before the high pressure extraction method. It is especially preferred that the starting material has not been subjected to an extraction using hexane before the high pressure extraction method.

Preferred plant material used for as starting materials included oilseeds, such as soybeans, canola, sunflower, rapeseed, camelina, flax, sesame, mustard, linseed and groundnut, but it is contemplated that any plant material could be used as the starting material. Other plant materials useful as starting materials include corn, high starch grains, as well as byproducts from processing of such grains; for example, wet distillers grains with soluble (WDGS) and dried distillers grans with soluble (DDGS). Starting materials for the high pressure extraction method preferably have been pre-processed to provide the plant material is a flaked; that is, cleaned, crushed, dehulled, conditioned, and flaked. The starting material is also preferably pre-processed such that the material is a liquid or liquefied. This may involve heating of the starting material to desired operating temperature (so as to liquefy the lipid to be extracted) and/or the addition of a carrier liquid (such as water).

In a preferred embodiment, the starting material has not been subjected to solvent extraction step (e.g. a hexane solvent extraction) before the high pressure extraction step. The absence of such an extraction step eliminates a source of contamination of the starting material and eliminates the risk of the resultant oil and meal be considered non-organic.

### EXAMPLES

The present method was performed at laboratory scale using a pressure autoclave filled with oilseed meal. The meal subjected to heating and contacted with CO₂ at increased pressure. Oil was recovered from a gas/liquid separator. The oilseed meal used the example was prepared by cleaning, dehulling, and extruding.

In the following example, oil content was determined according to AOCS, official method Ba 3-38 (revised 2017), entitled “Oil in selected metals and cams”. In general, a sample of the ground material was weighed and extracted according to the method, and the resulting extracted oil collected from the gas/liquid separator was weighed. The oil percentage is calculated by (grams of oil)/(grams of ground material)×100.

A 1.9 L pressure autoclave was filled with 1 kg soybean meal containing 20 wt % oil. The meal was heated to 40° C. and then contacted with 8 kg CO₂ at 2500 psig to extract 30 grams of oil, which was recovered from a gas/liquid separator. The first extracted flakes were contacted with an additional 40 kg CO₂ at 2500 psig to extract an additional 160 grams of oil. The residual oil in the twice extracted soybean flakes was reduced to about 1% by wt of oil. The oil recovered was clear and brilliant with little to no residual impurities. Because the recovered oil already meets AOCS trading rules or is essentially free of impurities, further processing of the oil is not necessary.

For DDGS, a similar process was used to determine whether the extraction method obtained any oil at all. Namely, a 1.9 L pressure autoclave was filled with 1 kg DDGS. The DDGS was heated to 40° C. and then contacted with 40 kg CO₂ at 2500 psig to extract oil, which was recovered from a gas/liquid separator. The recovered oil was clear and brilliant with little to no visual impurities.

For residual thin stillage from a distillery, a similar process was used to determine whether the extraction method obtained any oil at all. Namely, a 1.9 L pressure autoclave was filled with 1 kg thin stillage. The corn stover was heated to 40° C. and contacted with 40 kg CO₂ at 2500 psig to extract oil, which would be recovered from a gas/liquid separator. The recovered oil was clear and brilliant with little to no visual impurities.

### REFERENCE NUMERALS

| | |
|---|---|
| 100 | Extraction method |
| 110 | Extraction vessel |
| 120 | Flash vessel |
| 130 | Compressor |
| 140 | Flash Vessel |
| 150 | Compressor |

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature. Each parameter and each parameter in a range disclosed should be considered to be modified by the word “about” such that each parameter and parameter in a range includes plus-or-minus 10% of the indicated value.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. A method of extracting oil from plant matter comprising treating liquid or liquefied plant material to at least one high pressure extraction step comprising (i) contacting the plant material with CO₂ at pressure between 100 and 3000 psig; and (ii) separating the CO₂ and an extracted oil from the plant material to form an extracted plant meal, wherein the extracted plant meal comprises less than 2 wt % of residual oil, and wherein the liquid or liquefied plant material has not been previously extracted with a hydrocarbon solvent

2. The method of claim 1 wherein, during the contacting step and the separating step, the plant material is not heat treated.

3. The method of claim 2 wherein the contacting step takes place at pressures between 900 and 2000 psig and at temperatures between 275° F. and 350° F.

4. The method of claim 3 further comprising, after the separating step, flashing the CO₂ and the extracted oil at least once.

5. The method of claim 4 further comprising flashing the CO₂ and the extracted oil at least twice.

6. The method of claim 5 wherein the contacting step further comprising spraying the liquid or liquefied plant material into an extraction vessel in a continuous manner and batch removing the extracted plant meal.

7. The method of claim 1 wherein the extracted plant meal comprises less than 1 wt % of residual oil.

8. The method of claim 1 wherein the residual oil consists of oil.

9. The method of claim 1 wherein the residual oil consists essentially of oil.

10. The method of claim 1 wherein the residual oil is substantially free of impurities.

11. The method of claim 3 wherein the contacting steps takes place at pressures between 900 and 1500 psig and at temperatures between 290° F. and 310° F.

12. The method of claim 11 wherein the plant material comprises mechanically separated oilseed selected from the group consisting of soybeans, canola, sunflower, rapeseed, camelina, flax, sesame, mustard, linseed and groundnut, or from the group consisting of WDGS and DDGS.

13. The method of claim 12 wherein a mass flow rates of plant material is at least 5K lb/hr, at least 10K lb/hr, at least 15K lb/hr, at least 20K lb/hr, at least 25K lb/hr, at least 30K lb/hr, at least 35K lb/hr, at least 40K lb/hr, at least 45K lb/hr, or at least 50K lb/hr.

14. The method of claim 13 wherein the separating step results in results in extracted oil of more than 500 lb/hr, more than 1000 lb/hr, more than 2000 lb/hr, more than 3000 lb/hr, more than 4000 lb/hr, more than 5000 lb/hr, more than 6000 lb/hr, more than 7000 lb/hr, more than 8000 lb/hr, more than 9000 lb/hr, or more than 10000 lb/hr.

15. The method of claim 12 wherein the extracted oil meets or exceeds the trading rules crude degummed oil, once refined oil, or fully refined oil as set by American Oil Chemists' Society.
